(19) United States
(12) Patent Application Publication
(10) Pub. No.: US 2003/0118028 A1
(43) Pub. Date: Jun. 26, 2003

(54) Method and system of ensuring quality of service between networks using a signaling protocol

(76) Inventors: Warren Michael Neal, San Diego, CA (US); Gilbert Irving Cardwell, Laguna Beach, CA (US)

Correspondence Address: MICHAEL BEST & FRIEDRICH, LLP, 100 E WISCONSIN AVENUE, MILWAUKEE, WI, 53202, US

(21) Appl. No.: 10/069,747

(22) PCT Filed: Jul. 17, 2001
(86) PCT No.: PCT/US01/22414

(51) Int. Cl. H04L 12/28; H04L 12/56

(52) U.S. Cl. 370/395.21; 370/522

(57) ABSTRACT

A method and system for ensuring quality of service between a first network with a first quality of service and a second network with a second, different quality of service. The method includes dynamically mapping quality of service for data flows between the two networks using a signaling protocol common to the two networks. The system includes a first network, a second network, and a signaling protocol proxy coupled between the first and second networks. The signaling protocol proxy has a module that dynamically maps quality of service for data flows flowing between the first and second networks.

### BACKGROUND OF THE INVENTION

The present invention relates to methods and systems for communicating or transferring information between two networks. More particularly, the invention relates to ensuring quality of service between different networks by dynamically mapping quality of service parameters for data flows between the networks using a signaling protocol.

Widespread adoption of the Internet and Internet communication protocols, such as TCP/IP, has vastly improved many forms of communication. However, Internet-based networks are not suitable for the transfer of real-time data (as used herein “data” broadly encompasses all forms of information and data such as video, audio, text, etc.). The transfer of such data requires a defined level of network performance (referred to as “Quality of Service” or “QoS”) to timely and fully transfer the data from the source to one or more destinations. In response to this deficiency, network protocols having a defiable QoS, such as Asynchronous Transfer Mode (“ATM”) have been developed. While definable QoS protocols solve many of the problems associated with the Teal-time transfer of data, many entities have been reluctant to abandon existing legacy systems in favor of ATM networks. May legacy systems, such as Ethernet and Token Ring local area networks (“LANs”), do not provide QoS or a QoS that matches that provided by ATM networks. Thus, communication or data transfers between many legacy systems and definable QoS networks are usually compromised or otherwise adversely affected.

### SUMMARY OF THE INVENTION

Accordingly, it would be desirable to have a method and a system for improving data transfers between legacy and QoS networks. The invention provides a method for ensuring quality of service between a first network with a first quality of service and a second network with a second, different quality of service. The method includes mapping quality of service for data flows between the two networks using a signaling protocol common to the two networks. In one embodiment, the invention provides a method of ensuring quality of service in a connectionless network data flow when transmitting the data flow to a connection-oriented network. The method includes defining a quality of service for the connectionless network data flow; using a signaling protocol to reserve networking resources for the connectionless network data flow; and mapping the connectionless network data flow to the connection-oriented network.

The invention also provides a communication system that ensures quality of service between different networks. The system includes a first network and a first terminal coupled to the first network. The first terminal includes a signaling protocol module. The system also includes a second network and a second terminal coupled to the second network. The second terminal has a signaling protocol module. A proxy is coupled between the first and second networks and has a module that maps quality of service for data flows flowing between the first and second networks. Mapping is accomplished using a signaling protocol that is common to at least one of the terminals and the proxy.

The proxy is operable to determine QoS requirements based on signaling running atop a packet stream and includes a database for tracking bandwidth reservations. In one embodiment of the invention, the proxy functions as an endpoint for multicast transmissions and rewrites addresses of data flows using an application layer signaling protocol. In one embodiment, the application layer signaling protocol includes a stack and the proxy includes an application programming interface configured to communicate with the stack

As is apparent from the above, it is an advantage of the present invention to provide quality of service between different networks. Other features and advantages of the present invention will become apparent by consideration of the detailed description and accompanying drawings.

### BRIEF DESCRIPTION OF THE DRAWINGS

In the drawings:

FIG. 1 is an illustration of a network of the invention.

FIG. 2 is an illustration of part of the network of the invention

FIG. 3 is an illustration of a signaling protocol proxy of the invention.

FIG. 4 is an illustration of a client of the invention.

FIG. 5 is an illustration of two proxies converting and prioritizing traffic between two networks having different levels of quality of service.

### DETAILED DESCRIPTION

Before embodiments of the invention are explained in detail, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

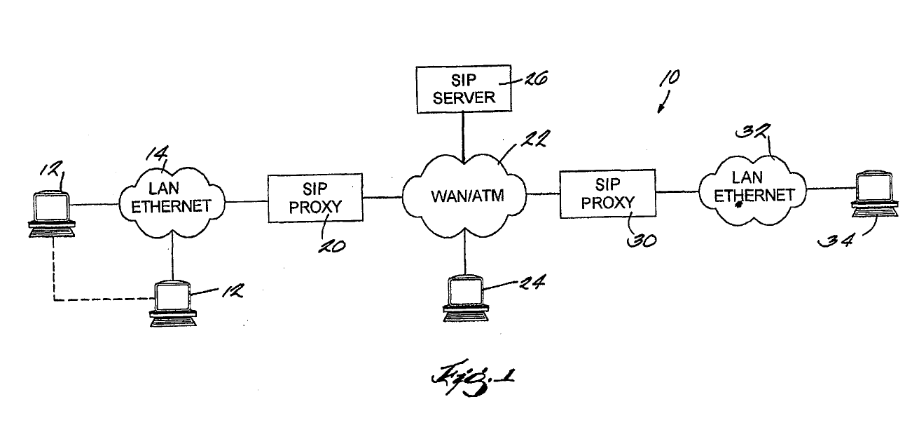

A system 10 embodying the invention is shown in FIG. 1. The system 10 includes a plurality of terminals or clients 12 connected to a legacy LAN 14 such as a Token Ring network or other network, or the exemplary Ethernet network shown. (Although described herein as clients, devices coupled to the networks described are terminals that transmit and receive data. The invention is not limited to client devices that request information. Further, as should be understood, the number of clients or other devices connected to any of the local area networks (“LANs”) or wide area networks (“WANs”) is not limited to the number illustrated in the drawings.

The LAN 14 is connected to a signaling protocol proxy 20, (hereinafter proxy 20), which processes data flows using a signaling protocol. As will be discussed in greater detail below, the signaling protocol is common to the LAN and other components of the system 10. Preferably, the signaling protocol used is Session Initiation Protocol (“SIP”).

As is known, SIP is an application-layer control protocol (OSI Model Application Layer Level 7) for creating, modifying, and terminating sessions with one or more participants. SIP invitations used to create sessions carry session descriptions which allow participants to agree on a set of compatible media types. SIP supports user mobility by proxying and redirecting requests to the user's current location. SIP is not tied to any particular conference control protocol and is designed to be independent of the lower-layer transport protocol.

The proxy 20 is coupled to a WAN 22, such as an ATM-based network. Various clients and servers, such as a client 24, may be coupled to the WAN 22. A signaling protocol server 26 is coupled to the WAN 22. The signaling protocol server 26 provides location and addressing services to the system 10 to enable proxies to locate endpoints or clients. A second signaling protocol proxy 30, (hereinafter proxy 30), is coupled to the WAN 22. A second LAN 32, having one or more clients 34, is coupled to the second proxy 30.

Having described the basic architecture of the invention, the operation of the system 10 will now be addressed. As noted above, maintaining a defined QoS when transferring data flows between QoS assured networks and non-QoS assured networks is difficult, if not impossible, to do with present technologies.

The inventors have found that to freely move data from one network to another (i.e., to enable transport independence) a mechanism should be provided to ensure QoS or to differentiate between traffic flows within the transiting networks. Secondly, a mechanism to signal the requirements across the transiting networks should be provided. The mechanism may take the form of a signaling protocol that is used to map addressing types for data flows from network to network. The signaling protocol also determines whether a data flow can travel through the receiving network with the desired or a suitable QoS.

ATM-based and other WANs already have mechanisms to relay and reserve QoS. LANs such as Ethernet networks do not provide strict resource reservation for traffic. Rather, most LANs support mechanisms that prioritize certain types of data flows. These mechanisms are known as classes of service (“CoS”) and types of service (“ToS”).

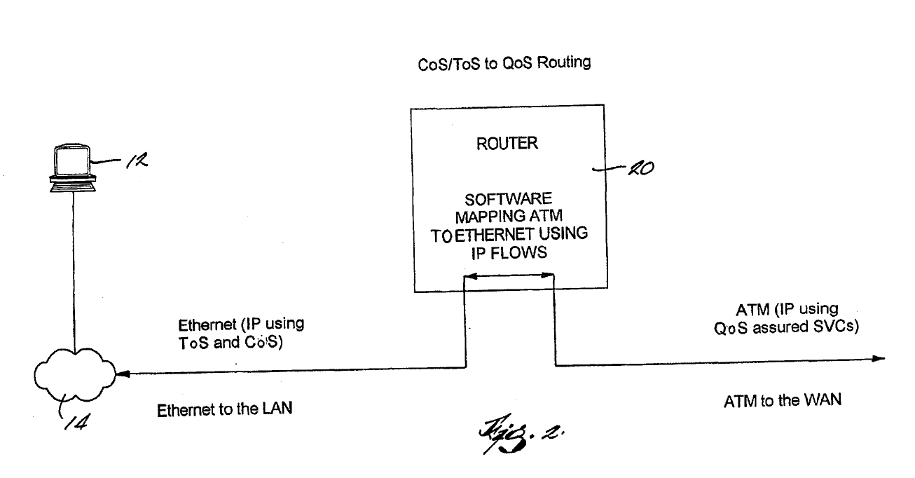

FIG. 2 illustrates the proxy 20, which provides an “edge box” that maps the QoS of the QoS assured WAN 22 to the priority-based LAN 14. In one embodiment, it is assumed that both the LAN 14 and WAN 22 handle Internet protocol (“IP”) data flows and the proxy 20 is designed to handle such data. The proxy 20 may also provide filtering between the LAN 14 and WAN 22 on components of the data flows, such as IP address (e.g., source and destination) or traffic flow types (e.g., http, telnet, etc.). It should be understood that the client 12, LAN 14, and proxy 20 sit on one side of the system 10 and that the proxy 30, LAN 32, and client 34 sit on another side of the system I 0. The proxy 20 and proxy 30 are essentially identical and virtually l of the discussion below is applicable to both sides or ends of the system 10. For the sake of brevity only one side will be discussed in detail.

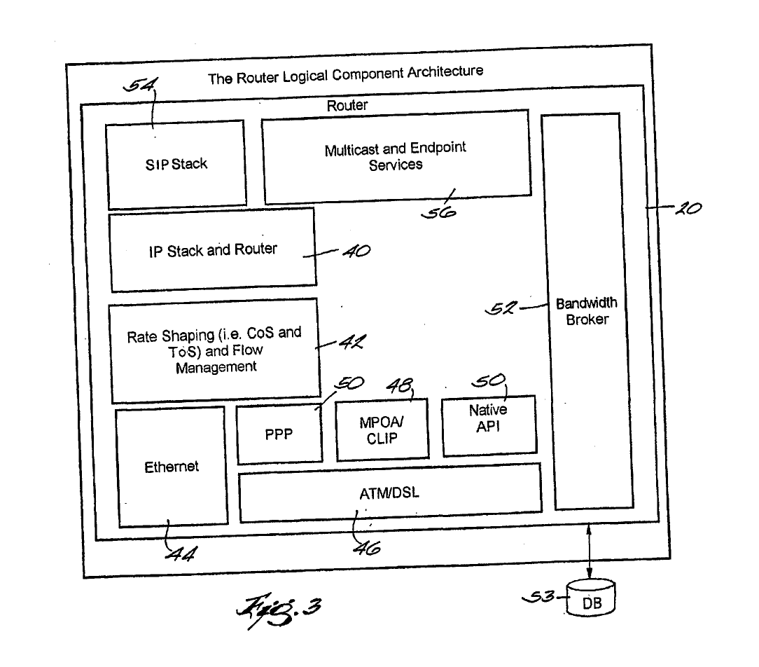

The proxy 20 is illustrated in greater detail in FIG. 3. As shown, the proxy 20 includes an IP stack and router module 40, which may include network address translation (“NAT”), dynamic host configuration protocol (“DHCP”), and Firewall options. The proxy 20 also includes a CoS and ToS tagging and flow management module 42, a LAN interface such as an Ethernet interface 44, and a WAN interface such as an ATM/Digital Subscriber Line (“DSL”) module 46. The proxy 20 also includes a Multiple Protocol Over ATM (“MPOA”)/Calling Line Identity Presentation (“CLIP”) module 48, a Point-to-Point Protocol (“PPP”) module 50, an Application Programming Interface (“API”) 58, and a bandwidth broker 52. Finally, the proxy 20 includes a database 53, a signaling protocol module 54, such as an SIP stack, and may include a multicast and endpoint services module 56.

The tagging and flow management module 42 is placed between the router module 40 and the endpoints of the system 10. As data packets are passed up and down the IP stack, the packets are tagged with CoS and ToS information by the tagging and flow management module 42.

Using the signaling protocol module 54, the proxy 20 translates session initiation requests into the native signaling protocols of the LAN 14 and WAN 22, or in the more general case the networks connected to the proxy 20. The proxy 20, unlike conventional routers, is aware of connection-oriented communications and the quality of service that they require. The proxy 20 determines the characteristics of the underlying networks and can allow, deny, or renegotiate connection-oriented traffic requests based on the available network infrastructure and capacity. This negotiation is done on behalf of the client 12, 34 without requiring the client 12, 34 to understand or even be aware of the negotiation

As noted, in one embodiment the proxy 20 implements an SIP stack 54. However, ensuring QoS may be accomplished by classifying data flows based on certain heuristics. For example, data flows can be managed based on IP destinations or port numbers. Thus, a “reserved channel” can be created between two network clients that require a specific class of service. Undefined network traffic is delivered normally, with a best effort solution. At worst, clients are offered service comparable to traditional networking solutions. The proxy 20 is also not limited to Ethernet/ATM transitions. There is no restriction on the physical layer transport, and other types of networks such as radio, packet over Synchronous Optical Network (“SONET”), Local Multipoint Distribution Service (“LMDS”), and Fiber Distributed Data Interface (“FDDI”) are encompassed by the invention.

The proxy 20 can operate as a conventional IP router. It can accept packets from one subnet and forward them to another. In the case where the router is ATM connected, it can participate in subnets that use Local Area Network Emulation (“LANE”) or CLIP protocols, for example. The IP stack and router module 40 recognizes conventional routing protocols, and supports differentiated services (“DiffServ”), and integrated services along with other signaling protocols like Resource Reservation Setup Protocol (“RSVP”).

The LAN or Ethernet interface 44 recognizes packets that are marked with different types of CoS, using IEEE 802.1p/Q tagging, for example. The signaling protocol module 54 listens for connection oriented requests for communications between groups of interfaces on the proxy 20. The proxy 20 also moderates communications between the respective communication modules and serves as a clearinghouse for requests for reservations or priorities of data movement within the proxy 20. The bandwidth broker module 52 keeps track of the total utilization of network bandwidth so that the proxy 20 may allow or deny calls as bandwidth allows.

In addition to the features discussed above, the proxy 20 supports multicasting. The multicast and endpoint services module 56 translates different network types. Multicasting is also controlled by extensions to the signaling protocol, allowing the clients 12 to specify the need for multicasting without necessitating their understanding of the underlying multicast architecture. As an example, ATM and Ethernet have different multicast schemes. If one client station on a remote ATM network is communicating with two clients on an Ethernet network that is local to the proxy 20, the proxy 20 automatically performs multicasting on the local network. This removes the need for the remote ATM client to transmit multiple data streams. During the negotiation of the call, the proxy 20 informs the remote client that the proxy 20, not the clients 12, 34, is to receive a single stream of transmitted data The proxy 20 then forwards the data flow to the Ethernet via multicast.

As an extension to this example, consider the remote client 34 connected to the LAN 32, which is connected to the WAN 22 through the proxy 30. When a call is placed, the remote client 34 signals via its local router and the remote proxy 30. The remote proxy 30, in turn, forwards the data stream to the clients 12 to action the call setup, tear down, or re-negotiation. The multicast happens on the remote and the local networks.

The more general case for multicast is having clients 12, 34 distributed over all types of transport media. The general solution is to set up multicast on all traversed networks including local and remote. However, the data should be multicast in such a way that it is only sent to clients 12, 34 that are interested in the data. With ATM, this is done with native ATM multicast; with Ethernet, this is done with broadcasts. With both transport mechanisms, the switches control the destination of the broadcast traffic.

The proxy 20 is capable of performing routing and address translation independent of the transport layer, and can rewrite addresses in the signaling protocol independent of the underlying addressing system. As an example, a pair of routers can tunnel IP traffic over an ATM wide area network (not shown). In this case, the end stations in the network view their respective routers as the endpoint of communication, and they are unaware of the tunnel. Because the proxy 20 is aware of the QoS necessary for conversations, it can arrange a dedicated QoS connection over the system 10.

The proxy 20 can perform protocol translations at the transport layer, (functionally equivalent to the OSI Model Transport Layer Level 4). The translations occur between two different devices on the network that could not ordinarily communicate with each other. For example, an ATM connected device that supports only Real-Time Transport Protocol (“RTP”) data streams over ATM Adaptation Layer 5 (“AAL5”) could try calling, via SIP, to an IP telephone connected via Ethernet Although both devices support RTP data streams (OST Level 4), the underlying protocols (ATM AAL5 and User Datagram Protocol (“UDP”)/IP) are different. Because it proxies the SIP signaling between the two devices, the proxy 20 can rewrite the SIP addresses to give the appearance that the two endpoints speak a common protocol. The proxy 20, in turn, serves as a translation device by giving both devices addresses that reside on the proxy 20 itself, or another designated translation device (not shown). The proxy 20 or designated translation device then moves the data from the AAL5 frames to UDP/IP as necessary.

As part of its address rewriting responsibility, the proxy 20 also allocates addresses for multicast groups. It rewrites addresses in the SIP signaling exchange in order to properly address multicast groups as necessary. It can choose an appropriate multicast address, and maintain a list of which multicast addresses are in use on the local network. The proxy 20 maintains associates between multicast groups on the different network interfaces it connects. What appears as an ATM multicast group on one side of the router might map to an IP/Ethernet multicast group on the other side.

In some cases, it is not merely sufficient to offer QoS for connection-oriented data streams. Sometimes the connection request must be rejected due to insufficient resources within the network. The proxy 20 keeps track of resource allocations for the connection-oriented streams in which it participates. During call setup, the proxy 20 serves as a bandwidth broker, metering out portions of the available network bandwidth to different connection requests. If a connection request cannot be fulfilled due to lack of bandwidth, the proxy 20 can signal via SIP that the connection cannot be completed. Alternatively, with appropriate authentication, a connection request can be made that forces existing connections to be terminated in favor of higher priority connections.

The proxy 20 is also able to reserve bandwidth for a data stream by acting as the endpoint for the call signaling. This is applicable when applications or clients and/or applications on one side support SIP, but SIP is not supported on the other end. QoS assurance is enabled by a user or application being able to handle call setup to the proxy 20 and the proxy 20 reserving onward resources for the data transfer. Applications can be made aware of the SIP services or a separate call control applet could be used for applications that do not support SIP. This lets a user specify the QoS for applications without the applications needing to be modified.

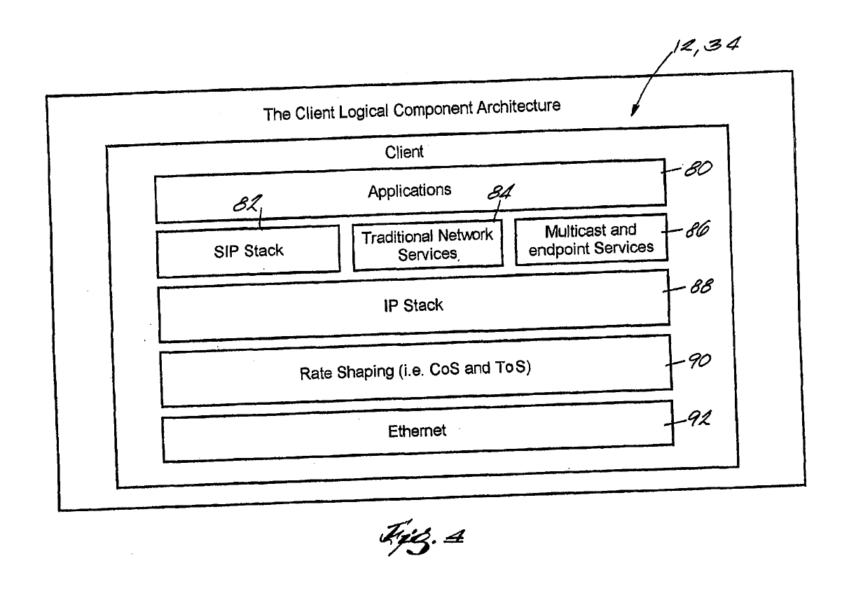

The client 12 is shown in detail in FIG. 4. In FIG. 4, data flows primarily in a vertical direction, although horizontal flows occur. As shown, the client 12 includes an applications layer 80, a signaling protocol module 82, a network services module 84, a multicast and endpoint services module 86, an IP stack module 88, a rate shaping module 90, and a LAN interface module 92. The interface module 92 shown is an Ethernet interface, however the interface is only an example. With different LANs, the structure of the client 12 changes. The client side has fewer components than the proxy 20, but has many of the same logical entities. Importantly, the client 12 shares a common signaling protocol with the proxy 20. That is, each of the signaling protocol modules 54 and 82 operate using the same signaling protocol.

The client side software can use the proxy 20 with or without SIP. Applications that are SIP aware can take advantage of the QoS assurance provided by the system 10. Other applications will get best effort data flow. Legacy applications are unaffected, but can be enhanced with an applet to work with QoS without being aware of QoS.

The SIP stack on the client 12 implements only user-agent functionality. The client 12 can only initiate and answer calls. It cannot serve as a proxy or application server. The client 12 is able to support the specific interface level quality of service capabilities. The multicast and endpoint services layer has interface specific codes to allow the client to use the native QoS capabilities. This usage is invisible to the client application program, which only needs to use the application programming interfaces provided by the endpoint services module.

Different versions of endpoint services are provided for different underlying interfaces (ATM, Ethernet, etc). The API for endpoint services in these cases remains the same, but the implementation details differ. This allows the endpoint services, in cooperation with the operating system, to offer CoS, traffic shaping, and data tagging as necessary to support QoS to another client 12 or to the proxy 20.

While the client 12 uses the local proxy as its SIP proxy 20, it does not necessarily use the proxy 20 for data transfer. The proxy 20 is responsible for allocation of network resources, even though it may not participate in the data transfer. As an example, a client 12 could be connected with ATM. This client 12 could call another client 34 that is also ATM connected. During the call setup, the proxy 20 would participate in the call signaling, serving as a proxy. However, the final data transfer occurs directly over the ATM network and switching fabric. The proxy 20 does, however, know of the call, and can keep track of the bandwidth allocated over the various links in the network using the database 53 to store information.

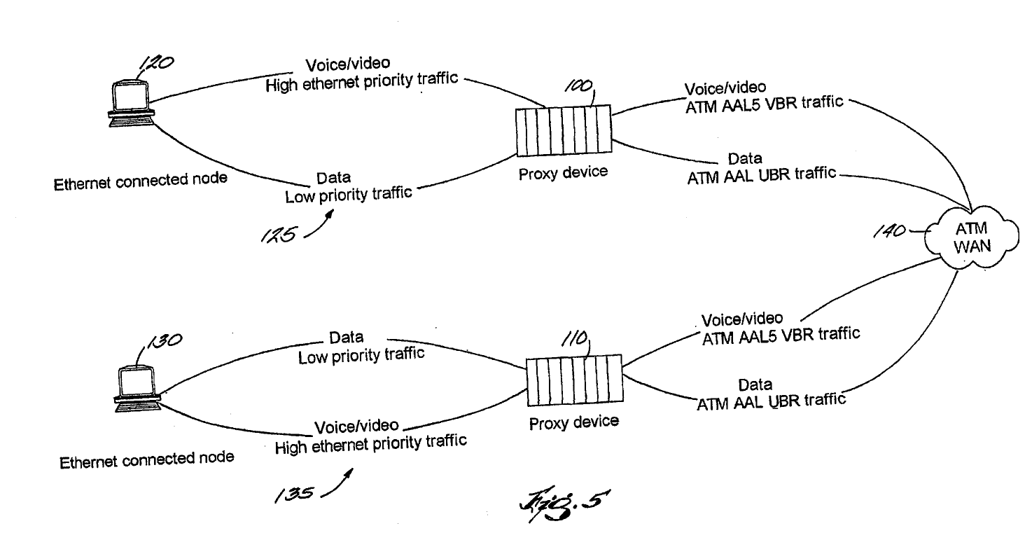

FIG. 5 illustrates two proxies 100 and 110 converting and prioritizing traffic between two networks having different levels of quality of service. In the example shown, the proxies 100 and 110 are handling traffic or data flows between a first terminal 120 and a first Ethernet LAN 125 and a second terminal 130 and second Ethernet LAN 135 through a WAN 140. Voice and video traffic is carried over the LANs 125 and 135 in high priority frames. Data is carried in low priority frames. Through signaling to the proxies, voice and video frames are arranged to enter the WAN 140 as variable bit rate (“VBR”) traffic. This reserves bandwidth in the WAN. As the data comes off the WAN, through the proxies, it is converted to Ethernet frames of appropriate priority.

As can be seen from the above, the invention provides a method and system for ensuring QoS between networks.

Various features and advantages of the invention are set forth in the following claims.

What is claimed is:

1. A method of ensuring quality of service between a first network with a first quality of service and a second network with a second, different quality of service, the method comprising dynamically mapping quality of service for data flows between the two networks using a signaling protocol common to the two networks.

2. A method as claimed in claim 1, wherein dynamic mapping of quality of service occurs at a proxy location.

3. A method as claimed in claim 1, wherein the signaling protocol is an application-layer control protocol.

4. A method as claimed in claim 3, wherein the signaling protocol is session initiation protocol.

5. A method as claimed in claim 1, further comprising translating session initiation requests into a native signaling protocol of the second network.

6. A method as claimed in claim 1, further comprising determining the connection characteristics of the first and second networks and allowing connection-oriented traffic requests based on available network capacity.

7. A method as claimed in claim 1, further comprising determining the connection characteristics of the first and second networks and denying connection-oriented traffic requests based on available network capacity.

8. A method as claimed in claim 1, further comprising determining the connection characteristics of the first and second networks and renegotiating connection-oriented traffic requests based on available network capacity.

9. A method as claimed in claim 1, further comprising rewriting signaling protocol addresses of data transiting the first and second networks.

10. A method as claimed in claim 9, further comprising moving data from a frame format to a packet format.

11. A method for ensuring quality of service in a connectionless network data flow when transmitting the connectionless network data flow to a connection oriented network, the method comprising defining a quality of service for the connectionless network data flow; using a signaling protocol to reserve networking resources for the connectionless network data flow; and mapping the connectionless network data flow to the connection oriented network.

12. A method as claimed in claim 11, wherein the signaling protocol is an application-layer control protocol.

13. A method as claimed in claim 12, wherein the signaling protocol is session initiation protocol.

14. A method as claimed in claim 11, further comprising translating session initiation requests into a native signaling protocol of the connection oriented network.

15. A method as claimed in claim 11, further comprising determining the connection characteristics of the connection oriented network and allowing connection-oriented traffic requests based on available network capacity.

16. A method as claimed in claim 11, further comprising determining the connection characteristics of the connection oriented network and denying connection-oriented traffic requests based on available network capacity.

17. A method as claimed in claim 11, further comprising determining the connection characteristics of the connection oriented network and renegotiating connection-oriented traffic requests based on available network capacity.

18. A method as claimed in claim 11, further comprising rewriting signaling protocol addresses of the data flow.

19. A method as claimed in claim 18, further comprising moving data from a packet format to a frame format.

20. A communication system comprising
a first network;
a second network; and
a proxy coupled between the first and second networks, the proxy configured to map quality of service for data flows flowing between the first and second networks.

21. A system as claimed in claim 20, wherein the proxy is operable to determine QoS requirements based on signaling running atop a packet stream.

21. A system as claimed in claim 20, wherein the proxy includes a database for tracking bandwidth reservations.

22. A system as claimed in claim 20, wherein the proxy functions as an endpoint for multicast transmissions.

23. A system as claimed in claim 20, wherein the proxy includes a signaling protocol module having an application layer signaling protocol and rewrites addresses of data flows using the application layer signaling protocol.

24. A system as claimed in claim 23, wherein the application layer signaling protocol includes a stack.

25. A system as claimed in claim 24, further comprising an application programming interface configured to communicate with the stack.

26. A system as claimed in claim 20, further comprising:
a first client coupled to the first network, the first client having a signaling protocol module; and
wherein the proxy includes a signaling protocol module and the signaling protocol modules of the client and the proxy share a common signaling protocol.

27. A communication system comprising
a first network;
a first terminal coupled to the first network and having a signaling protocol module;
a second network;
a second terminal coupled to the second network and having a signaling protocol module; and
a proxy coupled between the first and second networks and having a module that maps quality of service for data flows flowing between the first and second networks;
wherein the first and second terminals share a common signaling protocol.

28. A system as claimed in claim 19, wherein the proxy is operable to determine QoS requirements based on signaling running atop a packet stream.

29. A system as claimed in claim 20, wherein the proxy includes a database for tracking bandwidth reservations.

30. A system as claimed in claim 20, wherein the proxy functions as an endpoint for multicast transmissions.

31. A system as claimed in claim 20, wherein the proxy rewrites addresses of data flows using an application layer signaling protocol.

32. A system as claimed in claim 23, wherein the application layer signaling protocol includes a stack.

33. A system as claimed in claim 20, further comprising an application programming interface configured to communicate with the stack.

34. A proxy configured to ensure quality of service between a first network and a second network, the proxy comprising:
a signaling protocol module;
a router module;
a tagging and flow management module;
first network interface;
a second network interface;
an application programming interface; and
a bandwidth broker.
